(19) United States
(12) Patent Application Publication
(10) Pub. No.: US 2026/0017001 A1
(43) Pub. Date: Jan. 15, 2026

(54) METHOD AND SYSTEM FOR SECURELY GENERATING DOCUMENT VERIFICATION RECORDS

(71) Applicant: Xerox Corporation, Norwalk, CT (US)

(72) Inventors: Kevin St. Martin, Rochester, NY (US); David Roome, Geneseo, NY (US); Michael P. Kirby, Pittsford, NY (US)

(21) Appl. No.: 18/767,737

(22) Filed: Jul. 9, 2024

(51) Int. Cl. G06F 3/12

(52) U.S. Cl. CPC G06F 3/1222; G06F 3/1238

(57) ABSTRACT

Methods for providing security in a document printing process are disclosed. In various embodiments, when a system comprising a print device receives source document files, then before printing it may ensure that the system satisfies various security conditions before it will print verification document sheets based on the source document files. For example, the system may require that data from all prior print jobs be cleared from the memory. The system also may require that the print device be restricted from external communications, browser application usage, or both. After printing all verification document sheets for all of the source electronic document files, the system may restrict the print device from processing any future print jobs until all data associated with the source electronic document files and the verification document sheets have been removed from the print device.

### BACKGROUND

In recent years, the need to ensure the security and integrity of certain documents such as voter ballots and test papers has become extremely important.

In the case of voter ballots, the sanctity of the democratic process hinges upon the assurance that each vote is accurately recorded and counted. If the security or integrity of ballots is questioned, it can call the legitimacy of an election into question and erode public trust in the democratic process.

In the case of test papers, educational institutions require accurate and untampered test papers to determine what score to give the student who completed the test. Similarly, licensing authorities such as driver's license and professional licensing agencies need to ensure the integrity of a completed test to determine whether to grant a license to an applicant.

Thus, safeguarding the security and integrity of documents like voter ballots and test papers is essential for preserving the trust, fairness and legitimacy of democratic processes, educational systems and licensing administrators, among other entities.

When systems are used to generate secure documents such as those above, it is important not only that the systems be secure, but also that they be processed in a manner to ensure that data from one event (such as a primary election) is not commingled with data from another event (such as the general election that follows the primary election).

This document describes items, methods and systems that are designed to address the issues described above.

### SUMMARY

Methods and systems for securely generating document verification records, such as records verifying ballots or test answers, are disclosed. The method includes, by a system comprising a print device: receiving one or more source electronic document files, each of which includes content of one or more source documents, each associated with a unique content creator; causing a print engine of the print device to print a plurality of verification document sheets, each of which comprises data from at least one of the source documents; and after printing all verification document sheets for all of the source documents, restricting the print device from processing any future print jobs until all data associated with the source electronic document files and the verification document sheets have been removed from the print device.

### BRIEF DESCRIPTION OF THE DRAWINGS

FIG. 1 illustrates elements of an example system that may be used to receive and/or generate documents and deliver the documents to a secure document collection and storage container.

FIG. 2 illustrates components of an example multifunction print device that may be used with the system.

FIG. 3 illustrates example steps of a method of printing documents and securing the printed documents in a container.

FIG. 4 illustrates various processes implemented by a print device system before, during and after implementing the method of FIG. 3.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” signifies values that are within +/−10 percent of a stated value.

When used in this document, terms such as “top” and “bottom,” “upper” and “lower”, or “front” and “rear,” are not intended to have absolute orientations but are instead intended to describe relative positions of various components with respect to each other. For example, a first component may be a “front” or “top” component and a second component may be a “rear” or “bottom” component when a device of which the components are a part is oriented in a first direction. The relative orientations of the components may be reversed, or the components may be on the same plane, if the orientation of the structure that contains the components is changed. The claims are intended to include all orientations of a device containing such components.

Additional terms that are relevant to this disclosure will be defined at the end of this Detailed Description section.

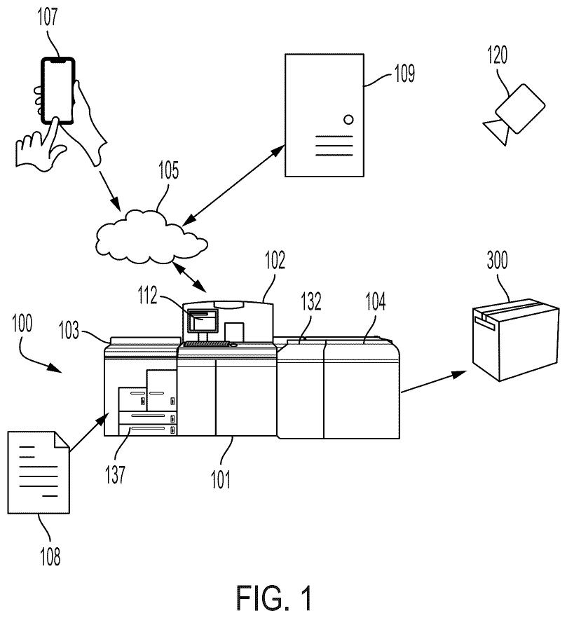

FIG. 1 illustrates an example system that may be used to generate verification documents based on original files or documents such as voting ballots or test answers. The system includes a print device 101, which in this case includes printing and scanning modules and thus may be considered to be part of a multifunction device (MFD) 100.

The MFD 100 also includes or is operatively connected to a sheet supply module 103 that includes a container that holds a supply of substrates onto which content can be printed. For example, sheet supply module 103 may include one or more substrate supply trays 137 such as a feeder drawer or roller with paper or other substrate that can deliver documents to a print engine of the print device 101. The supply trays 137 may hold substrates of different sizes, shapes, colors, and/or materials, or multiple supply trays may hold the same type of substrate. Substrate supply module 103 also may include a transport mechanism such as a document feeder, conveyor or rollers that can receive external documents (such as document 108) and direct the documents to a scanner of the MFD to be scanned.

The MFD 100 also includes a finishing module 104, which in this example includes a transport mechanism and a housing that is configured to hold a container 300 at a position where an opening of the container 300 is adjacent to or receives the distal end of the transport mechanism. When container 300 is placed in this position, the transport mechanism may directly deliver documents printed by the print device 101 into the container without any human touching the documents between printing and delivery. When container 300 is filled, or when all documents that are to be delivered into a container 300 have been delivered, the container 300 may be removed from the housing, and the opening of the container may be sealed. In other embodiments, the finishing module 104 may include a tray on which the documents are stacked, and a wrapping module that wraps or otherwise binds the stack of documents, such as with a plastic wrap, tamper-evident tape, string and/or wire, and/or other binding material.

The print device 101 and/or finishing module 104 also may include an additional processing module 132 such as a scanner with a camera that is configured to capture images of received documents. In various embodiments, the scanner will be positioned in a document handling path of the MFD 100 so that the scanner can capture images of documents after the print engine of the print device 101 prints the documents. The system may save each scanned image to a data store and optionally use the images as described below. In some embodiments, the additional processing module 132 may include a cutting device with a blade that is configured to trim or otherwise cut documents printed by the print engine.

MFD 100 also includes a computing device 102 which may include a processor, memory with programming instructions, memory for storage, and an optional user interface. The computing device 102 may be communicatively connected via a communication network 105 with external electronic devices such as a user electronic device 107 and/or external server 109. The communication network 105 may include one more wired communication networks, one or more wireless communication networks, or a combination of wired and wireless communication networks. The communication network may include a wireless network if the print device is not at the site where the document files are created.

Alternatively, to provide extra security the MFD 100 may be physically located at the facility where the document files are created, such as at a polling place, and communicatively isolated from external communication networks such as the Internet. In such situations, the only communication connection between the MFD and external devices may be a direct wired or wireless connection to the machines that are used to receive ballots cast by voters. Such machines may be voter kiosks into which voters cast their votes, or they may be vote scanning machines that read physical ballot documents onto which voters printed their votes. The direct connection may be one or more physical communication wires, and/or a direct JSON or socket connection, using encryption algorithms such as those approved by National Institute of Standards and Technology (NIST) with at least 112-bit encryption and/or methods having Federal Information Processing Standards (FIPS) 130 certification.

In some embodiments, the MFD may be housed on a vehicle and transported to polling places where the MFD's operations are needed. If the MFD is housed in a vehicle, it may include features and functions such as those described in U.S. Pat. No. 11,599,312, the disclosure of which is fully incorporated into this document by reference. Alternatively, if the MFD 100 is connected to an external communication network, a firewall and/or other security measures will be implemented in the communication path between the MFD 100 and the external network.

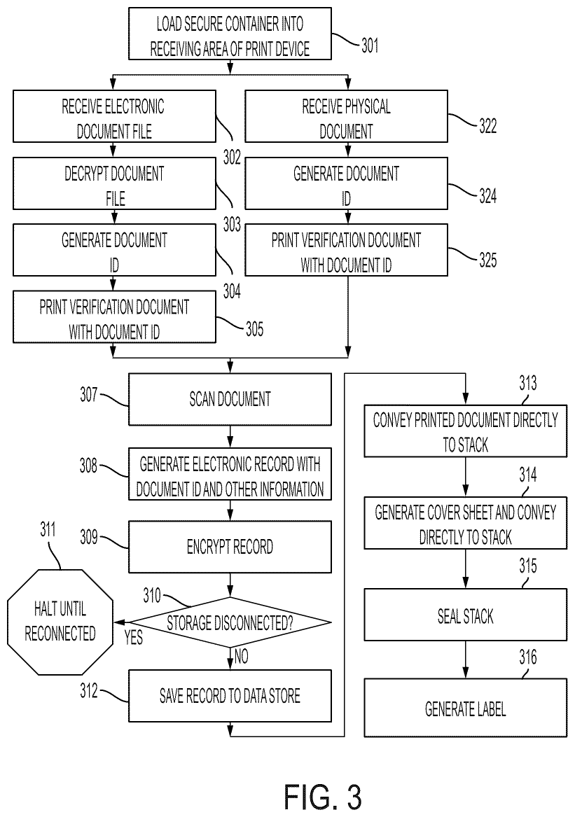

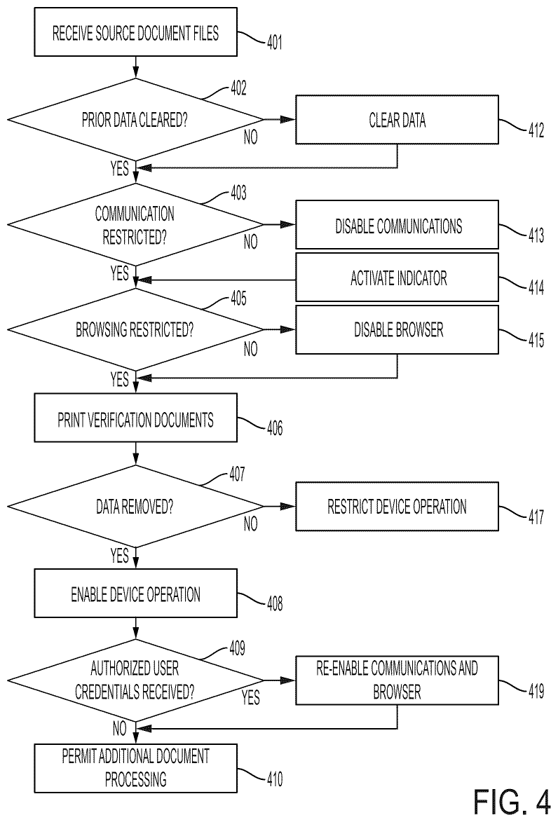

The computing device 102 may receive source document files from the user electronic device 107 and use the files to print verification document sheets containing content from the source files, as will be described below in the discussions of FIGS. 3 and 4. The user electronic device 107 may be an individual's personal computing device, or it may be a kiosk that is programmed for a specific function, such as a voting machine. The computing device 102 may send electronic records that the computing device 102 generates to the external server 109 for storage.

Optionally, MFD 100 also includes a document scanner, such as a scanner in additional processing module 132, that is positioned to receive document sheets that the print engine prints and capture an electronic image of each document. The system will save each scanned image to a data store and optionally use the images as described below.

The MFD 100 may be secured such that it requires an operator to present a credential a security token, enter a username and passcode, permit this system to take a photo or other action for biometric recognition, and/or take some other security measure before the system will operate to perform the functions described below. In addition, once the system accepts an operator credential, it may display information about the event for which it will operate, such as election name, district, county, and/or polling location.

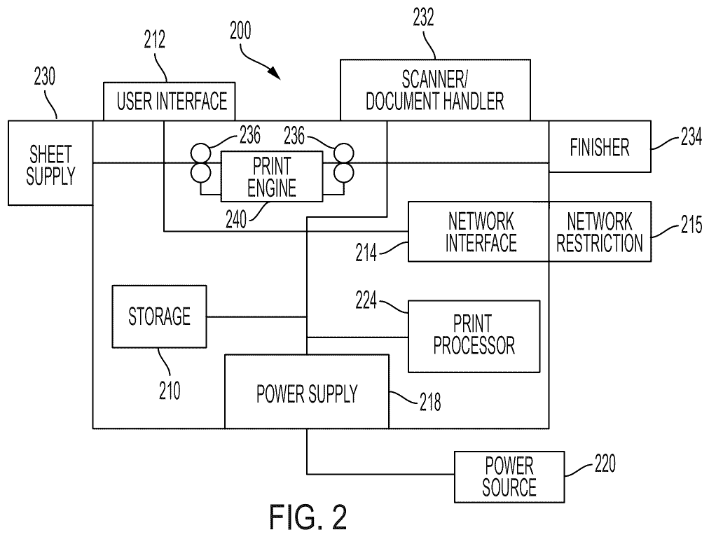

FIG. 2 illustrates components of an example MFD 200, which may serve as the MFD 100 of FIG. 1. MFD 200 may also be embodied as, or incorporated in, a printer, copier, multi-function machine, or other device that includes the capability to print, scan, and/or copy a document, including an electronic document, on a physical printable and/or readable media, such as paper. MFD 200 includes a print engine 240 capable of printing markings on sheets of print media, a processor 224 operatively coupled to the printing engine 240, a user interface 212 operatively coupled to the processor 224, and a network interface 214 operatively coupled to the processor 224 and print engine 240. Storage 210 is a data store that is also operatively coupled to network interface 214, processor 224, and print engine 240. Print engine 240 is also operatively coupled to sheet supply 230, scanner/document handler 232, media path 236, and optionally a finisher 234. Power supply 218 receives input from a power source 220 such as an external power outlet or a battery and provides power to components in MFD 200 including storage 210, network interface 214, processor 224, and print engine 240. Other elements may be included in MFD 200 but are not described here in the interest of conciseness.

In operation, processor 224 may receive an electronic document file and a request to print the document sheets on a substrate via the network interface 214. As noted above in the discussion of FIG. 1, the network interface 214 may include network restriction elements 215 such as those that only allow a hard-wired connection, and no wireless connection, in accordance with various standards. In addition or alternatively, the network restriction elements 215 may include a visual indicator such as a light or displayed symbol indicating that the system is connected—or confirming that the system is not connected—to any external network. Optionally, the system may include network restriction elements 215 may include an actuator that can be used to disconnect the system from external wireless networks, to disable any wireless communication elements in the system, and/or to actuate a signal that is configured to interfere with any wireless communication equipment that may be operative within the system.

In some embodiments, processor 224 or certain elements of it may be referred to as an image processor and may operate in a different manner than a general-purpose processor if it is specialized for processing image data. A printing mechanism is initiated by instructions in signals communicated from processor 224 to print engine 240. Media path 236 is positioned to supply continuous media or sheets of a print media substrate (e.g., paper or cardstock) from sheet supply 230 to the marking device(s) included in print engine 240. After print engine 240 generates and applies various markings to sheets of substrate, the sheets may optionally pass to finisher 234 which can flip, fold, staple, sort, collate etc., the various printed sheets based on the additional information associated with printing the electronic document. Finisher 234 may be part of the finishing module 104 of FIG. 1. In the embodiments of this disclosure, finisher 234 may include a conveyor that directly conveys the printed substrates into the secure storage container. In addition or alternatively, finisher 234 may include an output tray from which a human or a mechanical operator can lift the documents and move them to the container and/or bind the documents with a binding material.

MFD 200 also includes scanner 232 that includes a camera and a document handler with transport components (such as a conveyor or rollers) that will pass a document under the camera so that the camera may capture an image of the document. The scanner 232 may receive and capture a digital image of each document sheet printed by the print engine 240 so that the system can create an electronic record of each document sheet that the print engine 240 prints. If the system receives a physical document from an external source, scanner 232 also (or instead) may scan the document before printing a copy of the document.

Optionally, MFD 200 may include a user interface 212 that is configured to display one or more menus that may include selectable options and/or status reports for the print jobs to be printed. User interface 212 may receive instructions for displaying the menus from processor 224 and may further provide entry information to processor 224. The menus may include an option, selectable by the user, to create an electronic record associated with the printed and/or scanned document sheets. The electronic record is created by processor 224. The electronic record may include an identification for each of the verification sheets that enter a particular container. The electronic record may additionally include one or more informational elements, such as a table of contents, a stack ID or container ID, a date and/or time range during which the documents were printed, or other items. The electronic record may be one or more electronic files that are stored in the storage 210 and/or transmitted to an external storage (such as a memory of external server 109 of FIG. 1) via network interface 214. Optionally, the storage 210 may be a removable storage medium such as a removable hard drive, a USB drive, or another removable storage device that can be disconnected from the MFD and moved to a secure location.

FIG. 3 describes a process for generating verification copies of ballots, test papers or other documents and securing the verification copies in a secure stack or container using a system such as that described in FIGS. 1 and 2. In optional step 301, the method may include loading a secure container into a receiving area of a system that includes a print device. The loading will position the container to directly receive documents printed by the print device, such as inside the housing of finishing module 104 of FIG. 1. The secure container will include facets that are connected together to form a chamber. One of the facets of the container may be a front facet that has an opening that is sized with a width that equals or exceeds a width of documents that will be received into the chamber via the opening. The opening will be positioned between a top edge of the front facet and above a midpoint of the front facet. Thus, the container may be a secure container such as that described earlier in this document. Alternatively, the container may simply have an opening that is formed when its top facets are opened, and the system may deliver documents into the top of the container when its top facets are opened. As yet another option, the receiving area may simply include a tray for receiving the stack of documents, and after the stack is formed the system or a human operator may bind the stack with a binding material such as plastic wrap and/or tape.

The print device will print documents to be secured in the container or bound in the stack. The printed documents will be based on source documents that are either electronic document files or physical documents that the system receives. Electronic document files may be received in the form of images, in portable document file (pdf) format, or another format that can secure the integrity of the content of the document. If the system receives a source document in the form of an electronic document file (step 302) such as a digital ballot or a set of test answers, then at 304 the processor will generate a unique document ID for the source document, and at 305 (a) the processor will generate a print job, and (b) the print device's print engine will execute the print job to print a verification document sheet on a substrate. In embodiments in which the source document is a ballot, the document ID will be independent of any voter ID and will not be generated or stored in any way that associates the source document with the voter who cast the ballot. The verification document sheet will include the content of the electronic document file and the document ID for the source document. If the electronic file is encrypted, at 303 the processor will decrypt the document file upon receipt so that the print device may access the file's contents. Optionally, the system may receive document files at 302 in real-time as they are generated, such as directly from a voting machine via a communication network. (In this document, the term “real time” includes an action that happens within a very short period of time after a vote occurs, such as within a limited number of seconds or minutes, including both immediate action and near-real-time action.) Alternatively, the system may receive document files in one or more batches after various documents in a group of documents are created.

If the source document is a physical document (step 322) such as a printed ballot or a test paper, then at 324 the processor will generate a document ID for the document, and at 325 the print device will print a verification document sheet that is a copy the source document with the document ID and/or other content that the system may use to verify the printed document in the future.

In either case, the document ID generated at 304 or 324 may be taken from the electronic document file, or the processor may generate a new ID based on information in the electronic document file, based on a time of receipt and/or printing, or based on other information.

At 308 the processor will generate an electronic record that includes the document ID and other information relating to the verification document sheet, and at 312 the processor will save the document ID and other information to a data store. Such information may include, for example: (i) a unique ID for the stack or container in which the verification document sheet will be stored; (ii) a date and/or time at which the document file was received or the verification document sheet printed; (iii) a date and/or time at which the source document or source document file was generated; (iv) a batch ID for a subset of verification document sheets in the stack; (v) a ballot card ID for each document that is a ballot; and/or (vi) an identifier for the person who is the content creator of the source document, such as a voter ID for a ballot, or a student ID or applicant ID for a test. The system may save each verification document sheet's record in separate data files, or it may bundle a group of verification document sheet records in a single data file, such as by generating a single data file with records for all verification document sheets that are stored in a single stack or container. The data store to which the system stores the file or files may be that of the print device, that of an external server, or both. The data store may be external to the system, such as that of the voting authority, test administrator, or other source of the source document files, and if so the system may transmit the files directly to the external data store for storage, without keeping any digital copy of the files on any memory of the system that printed the documents and generated the files.

Optionally, before saving or transmitting the record to the data store at 312, the system may compress the record. Optionally, before saving or transmitting the record to the data store at 312, the system may encrypt the record at 309 so that the saved record is encrypted using at least a threshold level or type of encryption such as symmetric encryption, asymmetric encryption, encryption following the Advanced Encryption Standard (AES), Triple Data Encryption Standard (Triple DES or TDES), the RSA algorithm, Twofish, or other algorithms, any of all of which may use 128-bit, 192-bit, 256-bit or other bit size keys. The system may encrypt each record individually, or it may store multiple records and collectively encrypt a data set (such as a database) containing a group of the records.

After printing each verification document, at 313 the system may directly convey the verification document sheets from the print device into the stack, without any human touching the document sheets during the transfer, such as to form a stack of the verification document sheets within the chamber. In other embodiments, the system may convey the verification document sheets to an output tray of the system, from which a human operator or robotic device may remove the verification documents and place them into the container and/or bind the stack. At 315, the stack and/or the opening of the container will be sealed with a secure sealing material, such as tamper-evident tape, plastic wrap or other sealing materials described above. As the system sends the verification documents to the stack and/or container, the system may count the documents and stop the verification document printing process when the count reaches a maximum capacity of the stack or container.

Optionally, before conveying the verification document sheets to the container, a document scanning module (such one on additional processing module 132) will receive verification document sheets that the print engine prints and capture an electronic image of each verification document sheet, thus scanning the verification document sheet at 307. The system will save each scanned image to a data store and optionally use the images as described below.

Also optionally, after conveying all of the verification documents for the ballots, test results or other documents that are to be delivered to the stack and either before or after the stack or container is sealed, at 316 the system may generate a label containing any or all of the information described above in this paragraph, or other information.

At any point in the process, if a paper jam, toner cartridge error (i.e., a CRUM error), container filling error, container sealing error or other error occurs such that the verification documents are not properly delivered into and secured in the secure container, the system may generate an alert for an attendant to inspect the system. The system also may automatically unlock the finishing module and/or other access panels of the system to allow for system inspection and container removal. Optionally, after the inspection is complete and the issue is resolved, the system may require the operator to discard or archive the container and printed documents within it, and the system will restart the process by re-printing the first verification document that was generated for the stack, along with all subsequent verification documents and slip sheets for that stack, and delivering those documents to a new stack.

In the method, each of the verification document sheets may correspond to a unique ballot cast by a unique voter, a unique test answer sheet containing answers from a student or applicant in response to a test, or any other unique source document for which secure storage and/or verification of authenticity are desirable.

Optionally, after the container is filled and sealed, and if all validation steps listed above were completed, the MFD may print a label indicating that the container was successfully filled and sealed. If an error or validation failure occurred at any point in the process, the MFD may print a label indicating that an error occurred and/or the container was unsuccessfully filled and sealed. In either situation, the label may be affixed to the container or stack before and/or after the container or stack is removed from the MFD.

Also optionally, the MFD may require an operator to enter a valid credential before the MFD will unlock the finishing module 104 and permit the operator to remove the container or stack from the MFD.

Optionally, at any point in the process, if the system detects that the storage device to which the system is saving the electronic records has become disconnected (310: YES), at 311 the system will halt the process by stopping the print engine and/or scanner of the MFD from processing additional verification documents. For example, if the storage device is a universal serial bus (USB) memory device, a portable hard drive lor another removable storage medium attached to the MFD, and if the device has been removed, the system may halt the process until the removable storage medium is reconnected. Also optionally, before resuming the process, the system may require verification that the reconnected storage medium is the same medium that was disconnected and the contents of the storage medium have not been altered. This will be described in more detail in the discussion of FIG. 4. If the system cannot verify that the reconnected storage medium is the same device and/or its contents have not been altered, the system may require an administrator to provide approval before resuming its process.

In addition, at any point in the process an authorized operator may enter a pause command into the system's user interface 212. Upon receipt of a pause command, the system may halt printing of verification documents and sending data to the data store until the system receives a resume command from the authorized operator via the user interface. Optionally, before halting the process, the system may require the operator to provide additional information that the system requires to verify the pause command. For example, the system may require the operator to enter a reason for the pause command, and the system will only halt operation if the reason is one that the system has stored as a qualifying reason. Example qualifying reasons may include, for example, operator shift change or break time, addition of print device consumables (such as toner or paper), inspection required due to system error or repeated system error, or other reasons. In addition, the system may automatically implement a pause command upon detection of certain conditions, such as a container full condition, a paper jam condition, or a condition requiring addition of consumables such as paper or toner.

FIG. 4 illustrates additional processes that may be implemented before, during and/or after printing of verification documents to provide additional security in the process. At 401, the system that includes an MFD or other type of print device will receive source electronic document files, each of which includes content of a source document associated with a unique content creator. The source document files may be ballots, test answers or other documents as described in previous sections of this disclosure.

In some embodiments, before printing and/or taking other actions based on the source documents, the system may ensure that all data from prior print events has been cleared from the print device. The system may do this by accessing a log file to determine whether all relevant data storage devices in the system have been cleared of data from previous print jobs in accordance with approved protocols. The log file will be a local file containing a record of actions that the print device implemented during a time range that is immediately prior to the current time. For example, the system may determine that prior print job data was properly cleared if the log file includes a record showing that previously-stored print job data was overwritten by a data overwrite process that wrote a set of randomly generated and/or default data over the previous print job data. Alternatively, the system may determine that prior print job data was properly cleared if the log file includes a record showing that a drive format operation was performed on the memory device or segment of a memory device on which the previous print job data was stored.

If the system determines that the prior print job data was properly cleared (402: YES), then the system may process the source document files and print verification documents 406 for each of the source document files as described in the discussion of FIG. 3. However, in some embodiments, the system may also require that other conditions also be satisfied before moving to step 406. Examples of such conditions will be described below. If the system cannot determine that the prior print job data was cleared in accordance with an approved protocol (402: NO), then at 412 the system may implement an approved protocol to clear the prior print job data before proceeding. Example protocols may include data overwrite and hard drive format operations as described above, and/or other methods of securely removing stored data from memory.

After printing all verification document sheets for all of the source electronic document files, at 417 the system may restrict the print device from processing any future print jobs until all data associated with the source electronic document files and the verification document sheets have been removed from the print device. If the system can confirm that all data for the current print job has been removed in accordance with accepted protocols (407: YES) using processes similar to those discussed above in step 402, then at 408 the system may enable device operation and at 410 it may permit additional documents to be printed. If the system cannot confirm that all data for the current print job has been removed (407: NO), then the system may restrict future print operations until the data from the current print job was removed in accordance with approved protocols. This process may ensure that, for example, after a first election is complete and before the printer is used to process new verification documents for ballots from a second election or any other print job, all data from the first election is removed from the print device.

In some embodiments, before causing the print engine to print any of the verification document sheets, at 403 the system may confirm whether the print device system can communicate with any external systems or devices. The print device may be permitted to communicate with the source document provider by a secure communication link such as a direct socket connection or a hard wired communication path. In some situations, the print device's operating system or registry settings may be programmed to restrict the print device from communicating with any external system other than that of the source document provider by a secure communication link. In such situations, restricted external communications may not be enabled without significant alteration to the device, such as a new operating system installation. However, if external communication has not been temporarily or permanently restricted or otherwise disabled (403: NO), then at 413 the system will disable all other communication paths while the device prints the verification documents. To disable communications, in some embodiments the system may activate a registry setting in an operating system of the print device that disables all ports of the print device from communicating with external storage devices. If this happens, the system may not reverse the registry setting and re-enable external communications (step 419) until the system receives user credentials from a user whose credentials are associated with authority to enable the communications. Other methods of disabling communications may be used. For example, the system may disable various communication ports and transceivers. In some embodiments, the system may activate a jamming signal that is configured to disrupt wireless communication signals from reaching or exiting from the print device. This process may ensure that, for example, before the print device is used to process verification documents for an election, the print device can only receive information from a single source (such as a particular polling place or election authority) and from no other source.

Optionally, when the communication path is disabled, at 414 the system may cause a user interface element of the print device to output a visual indicator that the communication elements of the print device have been disabled. The user interface may be a display device (such as display 112 of FIG. 1), an indicator light, or any other device that is operable to change between at least two visually perceptible states. Alternatively and equivalently, instead of (or in addition to) outputting a visual indicator that indicates when communication elements of the print device have been disabled, the system may output a visual indicator that indicates when communication elements of the print device have been enabled (409: YES).

In some embodiments, before causing the print engine to print any of the verification document sheets, at 405 the system may confirm whether the print device system can permit operation with external systems via a browser application. However, if browser operation has not been disabled (405: NO), then at 415 the system will disable browser operations while the device prints the verification documents. If this happens, the system may not re-enable browsing operations (step 419) until the system receives user credentials from a user whose credentials are associated with authority to enable browsing operations (409: YES).

In various embodiments, the software and/or firmware that is configured to cause the system to perform the functions described in FIGS. 3 and 4 will be stored solely in memory of the MFD 200, so that no external systems need to be accessed in order for the functions described above to be completed.

The following paragraphs provide more information about certain terms used in this document.

In this document, the term “multi-function device” (or “MFD”) refers to a machine comprising hardware and associated software configured to enable the device to print documents on substrates, as well as perform at least one other function such as copying, facsimile transmitting or receiving, image scanning, or performing other actions on document-based data.

The term “print device” refers to a machine having hardware capable of reading digital data and using the information from the data and associated print instructions to print a physical document on a substrate. In some embodiments, a print device may have additional capabilities such as scanning or faxing, and thus in some embodiments a print also may be a multi-function device. Components of a print device typically include a print engine, which includes print hardware such as a print head, which may include components such as a print cartridge containing ink, toner or another print material, as well as a document feeding system configured to pass a substrate through the print device so that the print head can print characters and/or images on the substrate.

The term “print engine” refers to the marking hardware of a print device, such as a print head, along with marking material storage and delivery components such as a print cartridge containing ink, toner or another marking material. A print engine also includes conveyors, rollers or other media transport components that are configured to move a substrate past the print head to receive printed images onto the substrate. In an inkjet printing system, the marking material storage and delivery components may include one or more printheads arranged in a print zone that eject ink drops onto the substrate. In a laser printer, the marking material storage and delivery components may include toner, a laser, and related components configured to transfer the toner onto the substrate.

The term “print job” refers to digital data embodied in a set of instructions and/or parameters that can guide operation of a print engine to print content on a substrate.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include voting machines in various applications of this disclosure. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A “computer program product” is a memory device with programming instructions stored on it.

An “imaging device” refers to any device capable of optically viewing an object and converting an interpretation of that object into electronic signals. One such example of an imaging device is a camera. Another example is the image sensing hardware of an electronic device that is used to capture images, such as a document scanner.

The features and functions described above, as well as alternatives, may be combined into many other different systems or applications. Various alternatives, modifications, variations or improvements may be made by those skilled in the art, each of which is also intended to be encompassed by the disclosed embodiments.

Without excluding further possible embodiments, certain example embodiments are summarized in the following clauses:

Clause 1: A method of providing security to a document printing process, the method comprising, by a system comprising a print device: (a) receiving one or more source electronic document files, each of which includes content of one or more source documents, each associated with a unique content creator; (b) causing a print engine of the print device to print a plurality of verification document sheets, each of which comprises data from at least one of the source documents; and (c) after printing all verification document sheets for all of the source documents, restricting the print device from processing any future print jobs until all data associated with the source electronic document files and the verification document sheets have been removed from the print device.

Clause 2: The method of clause 1 further comprising, before causing the print engine to print any of the verification document sheets: (a) activating a registry setting in an operating system of the print device that disables all ports of the print device from communicating with external storage devices; and (b) not reversing activation of the registry setting unless and until the print device receives credentials associated with a user who is authorized to enable communication with the external storage devices.

Clause 3: The method of clause 1 or 2, further comprising communicatively connecting with a provider of the source electronic document files via a secure socket connection and, before causing the print engine to print any of the verification document sheets: (a) activating a registry setting in an operating system of the print device that disables all communication elements of the print device other than the secure socket connection from communicating with external devices and systems; and (b) not permitting reversal of the registry setting unless and until the print device receives credentials associated with a user who is authorized to enable communication with the external devices and systems.

Clause 4: The method of clause 2 or 3 further comprising, upon activation of the registry setting, causing a user interface element of the print device to output a visual indicator that the communication elements of the print device have been disabled.

Clause 5: The method of clause 2 or 3 further comprising, upon reversal of the registry setting, causing a user interface element of the print device to output a visual indicator that the communication elements of the print device have been enabled.

Clause 6: The method of clause 1, further comprising communicatively connecting with a provider of the source electronic document files via a secure socket connection and, while printing of the verification document sheets, restricting the print device from communicating with any external system other than the provider via the secure socket connection.

Clause 7: The method of any of clauses 1-6, further comprising, after printing each verification document sheet: (a) causing a scanner of the print device to scan each verification document sheet to capture a digital image of the verification document sheet; and (b) saving the digital images of the verification document sheets to a data store.

Clause 8: The method of any of clauses 1-6, further comprising, after printing each verification document sheet: (a) causing a scanner of the print device to scan each verification document sheet to capture a digital image of the verification document sheet, and (b) directly transmitting the digital images of the verification document sheets to a source of the source electronic document files without retaining any digital copy of the verification document sheets or the source document sheets in any memory of the print device.

Clause 9: The method of any of any of clauses 1-8, wherein restricting the print device from processing any future print jobs until all data associated with the source electronic document files and the verification document sheets has been removed from the print device comprises, after printing all verification document sheets for all of the plurality of source electronic document files, confirming that (a) a data store has been physically removed from the print device, or (b) all data associated with the source electronic document files has been removed by an approved protocol.

Clause 10: The method of clause 9 further comprising, in response to detecting that a data store has been removed from the print device, stopping a scanner of the print device from operating.

Clause 11: The method of any of clauses 1-10 further comprising, before accepting the plurality of source electronic document files, confirming that the print device does not contain any data associated with the other source electronic document files or other verification document sheets from another print job.

Clause 12: The method of any of clauses 1-11, further comprising placing each verification document sheet into a secure container and, after printing all verification document sheets for all of the plurality of source electronic document files that are to be secured in the container, sealing the container with tamper-evident tape.

Clause 13: A computer program product for providing security to a document printing process, the computer program product comprising a memory containing programming instructions that are configured to cause a processor of a print device, upon receiving one or more source electronic document files, each of which includes content of one or more source documents, each associated with a unique content creator, implement a method according to any of clauses 1-12.

1. A method of providing security to a document printing process, the method comprising, by a system comprising a print device:
receiving one or more source electronic document files, each of which includes content of one or more source documents, each associated with a unique content creator;
causing a print engine of the print device to print a plurality of verification document sheets, each of which comprises data from at least one of the source documents; and
after printing all verification document sheets for all of the source documents, restricting the print device from processing any future print jobs until all data associated with the source electronic document files and the verification document sheets have been removed from the print device.

2. The method of claim 1 further comprising, before causing the print engine to print any of the verification document sheets:
activating a registry setting in an operating system of the print device that disables all ports of the print device from communicating with external storage devices; and
not reversing activation of the registry setting unless and until the print device receives credentials associated with a user who is authorized to enable communication with the external storage devices.

3. The method of claim 1, further comprising:
communicatively connecting with a provider of the source electronic document files via a secure socket connection,
wherein the method further comprises, before causing the print engine to print any of the verification document sheets:
activating a registry setting in an operating system of the print device that disables all communication elements of the print device other than the secure socket connection from communicating with external devices and systems, and
not permitting reversal of the registry setting unless and until the print device receives credentials associated with a user who is authorized to enable communication with the external devices and systems.

4. The method of claim 3 further comprising, upon activation of the registry setting, causing a user interface element of the print device to output a visual indicator that the communication elements of the print device have been disabled.

5. The method of claim 3 further comprising, upon reversal of the registry setting, causing a user interface element of the print device to output a visual indicator that the communication elements of the print device have been enabled.

6. The method of claim 1, further comprising:
communicatively connecting with a provider of the source electronic document files via a secure socket connection; and
while printing the verification document sheets, restricting the print device from communicating with any external system other than the provider via the secure socket connection.

7. The method of claim 1, further comprising, after printing each verification document sheet:
causing a scanner of the print device to scan each verification document sheet to capture a digital image of the verification document sheet; and
saving the digital images of the verification document sheets to a data store.

8. The method of claim 1, further comprising, after printing each verification document sheet:
causing a scanner of the print device to scan each verification document sheet to capture a digital image of the verification document sheet; and
directly transmitting the digital images of the verification document sheets to a source of the source electronic document files without retaining any digital copy of the verification document sheets or the source document sheets in any memory of the print device.

9. The method of claim 1, wherein restricting the print device from processing any future print jobs until all data associated with the source electronic document files and the verification document sheets has been removed from the print device comprises, after printing all verification document sheets for all of the plurality of source electronic document files, confirming that:
the data store has been physically removed from the print device; or
all data associated with the source electronic document files has been removed by an approved protocol.

10. The method of claim 9 further comprising, in response to detecting that the data store has been removed from the print device, stopping a scanner of the print device from operating.

11. The method of claim 1 further comprising, before accepting the plurality of source electronic document files, confirming that the print device does not contain any data associated with the other source electronic document files or other verification document sheets from another print job.

12. The method of claim 1, further comprising:
placing each verification document sheet into a secure container; and
after printing all verification document sheets for all of the plurality of source electronic document files that are to be secured in the container, sealing the container with tamper-evident tape.

13. A computer program product for providing security to a document printing process, the computer program product comprising:
a memory containing programming instructions that are configured to cause a processor of a print device, upon receiving one or more source electronic document files, each of which includes content of one or more source documents, each associated with a unique content creator:
cause a print engine of the print device to print a plurality of verification document sheets, each of which comprises data from at least one of the source documents, and
after printing all verification document sheets for all of the source documents, restrict the print device from processing any future print jobs until all data associated with the source electronic document files and the verification document sheets have been removed from the print device.

14. The computer program product of claim 13 further comprising additional programming instructions to, before causing the print engine to print any of the verification document sheets:
activate a registry setting in an operating system of the print device that disables all ports of the print device from communicating with external storage devices; and
not reverse activation of the registry setting unless and until the print device receives credentials associated with a user who is authorized to enable communication with the external storage devices.

15. The computer program product of claim 13, further comprising additional programming instructions to, after printing each verification document sheet:
cause a scanner of the print device to scan each verification document sheet to capture a digital image of the verification document sheet; and
save the digital images of the verification document sheets to a data store.

16. The computer program product of claim 13, further comprising additional programming instructions to, after printing each verification document sheet:
cause a scanner of the print device to scan each verification document sheet to capture a digital image of the verification document sheet; and
directly transmit the digital images of the verification document sheets to a source of the source electronic document files without retaining any digital copy of the verification document sheets or the source document sheets in any memory of the print device.

17. The computer program product of claim 13, wherein the instructions to restrict the print device from processing any future print jobs until all data associated with the source electronic document files and the verification document sheets has been removed from the print device comprise instructions to, after printing all verification document sheets for all of the plurality of source electronic document files, confirm that:
the data store has been physically removed from the print device; or
all data associated with the source electronic document files has been removed by an approved protocol.

18. The computer program product of claim 13 further comprising instructions to, in response to detecting that the data store has been removed from the print device, stop a scanner of the print device from operating.

19. The computer program product of claim 13, further comprising additional programming instructions to, before causing the print engine of the print device to print a plurality of verification document sheets, confirm that the print device does not contain any data associated with the other source electronic document files or other verification document sheets from another print job.
